(19) United States
(12) Patent Application Publication
(10) Pub. No.: US 2005/0193172 A1
(43) Pub. Date: Sep. 1, 2005

(54) Method and apparatus for splitting a cache operation into multiple phases and multiple clock domains

(76) Inventors: Anoop Mukker, Folsom, CA (US); Zohar Bogin, Folsom, CA (US)

Correspondence Address: Sanjeet K. Dutta;Blakely, Sokoloff, Taylor & Zafman LLP, 7th Floor, 12400 Wilshire Boulevard, Los Angeles, CA, 90025, US

(21) Appl. No.: 10/788,615

(22) Filed: Feb. 26, 2004

(51) Int. Cl. G06F 12/00

(52) U.S. Cl. 711/118; 711/167; 713/501

(57) ABSTRACT

A method and apparatus for splitting a cache operation into multiple phases and multiple clock domains are disclosed. The method according to the present techniques comprises splitting a cache operation into two or more phases and two or more clock domains.

### FIELD OF THE INVENTION

The present embodiments of the invention relate to the field of computer systems. In particular, the present embodiments relate to a method and apparatus for splitting a cache operation into multiple phases and multiple clock domains.

### BACKGROUND OF THE INVENTION

Caches are commonly used to temporarily store values that might be repeatedly accessed by a processor, in order to speed up processing by avoiding the longer operation of loading the values from main memory such as random access memory (RAM).

An exemplary cache line (block) includes an address-tag field, a state-bit field, an inclusivity-bit field, and a data field for storing the actual instruction or data. The state-bit field and inclusivity-bit field are used to maintain cache coherency in a multiprocessor computer system. The address tag is a subset of the full address of the corresponding memory block. A compare match of an incoming effective address with one of the tags within the address-tag field indicates a cache “hit.” The collection of all of the address tags in a cache (and sometimes the state-bit and inclusivity-bit fields) is referred to as a directory, and the collection of all of the value fields is the cache entry array.

When all of the blocks in a set for a given cache are full and that cache receives a request, with a different tag address, whether a “read” or “write,” to a memory location that maps into the full set, the cache must “evict” one of the blocks currently in the set. The cache chooses a block to be evicted by one of a number of means known to those skilled in the art (least recently used (LRU), random, pseudo-LRU, etc.).

A general-purpose cache receives memory requests from various entities including input/output (I/O) devices, a central processing unit (CPU), graphics processors and similar devices. These entities are continuously making memory accesses, often for the same data. For example, an entity may request data from system memory, and a cache miss occurs. The cache requests the data, from system memory, but before the data is received, another request for the same data is received by the cache, resulting in another cache miss, even though the requested data is on its way. Present caches such as that described above, only provide for tag components such as address, status, and cache data to be updated and used in the same clock domain.

### BRIEF DESCRIPTION OF THE DRAWINGS

The present embodiments of the invention will be understood and appreciated more fully from the following detailed description taken in conjunction with the drawings in which:

FIG. 1 illustrates a block diagram of an exemplary computer system utilizing the present method and apparatus, according to one embodiment of the present invention;

FIG. 2 illustrates a block diagram of an exemplary graphics memory controller hub utilizing the present method and apparatus, according to one embodiment of the present invention;

FIG. 3 illustrates a block diagram of an exemplary two-phase cache, according to one embodiment of the present invention;

FIG. 4 illustrates an exemplary timing diagram of a two-phase cache operation, according to one embodiment of the present invention; and

FIG. 5 illustrates a flow diagram of an exemplary process of providing a two-phase cache, according to one embodiment of the present invention.

### DETAILED DESCRIPTION

A method and apparatus for splitting a cache operation in to multiple phases and multiple clock domains are disclosed. The method according to the present techniques comprises splitting a cache operation into two or more phases and two or more clock domains.

In the following description, for purposes of explanation, specific nomenclature is set forth to provide a thorough understanding of the present invention. However, it will be apparent to one skilled in the art that these specific details are not required in order to practice the present invention. For example, the present invention has been described with reference to documentary data. However, the same techniques can easily be applied to other types of data such as voice and video.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method. The required structure for a variety of these systems will appear from the description below. In addition, one embodiment of the present invention is not described with reference to any particular programming language. It will be appreciated that a variety of programming languages may be used to implement the teachings of embodiments of the invention as described herein.

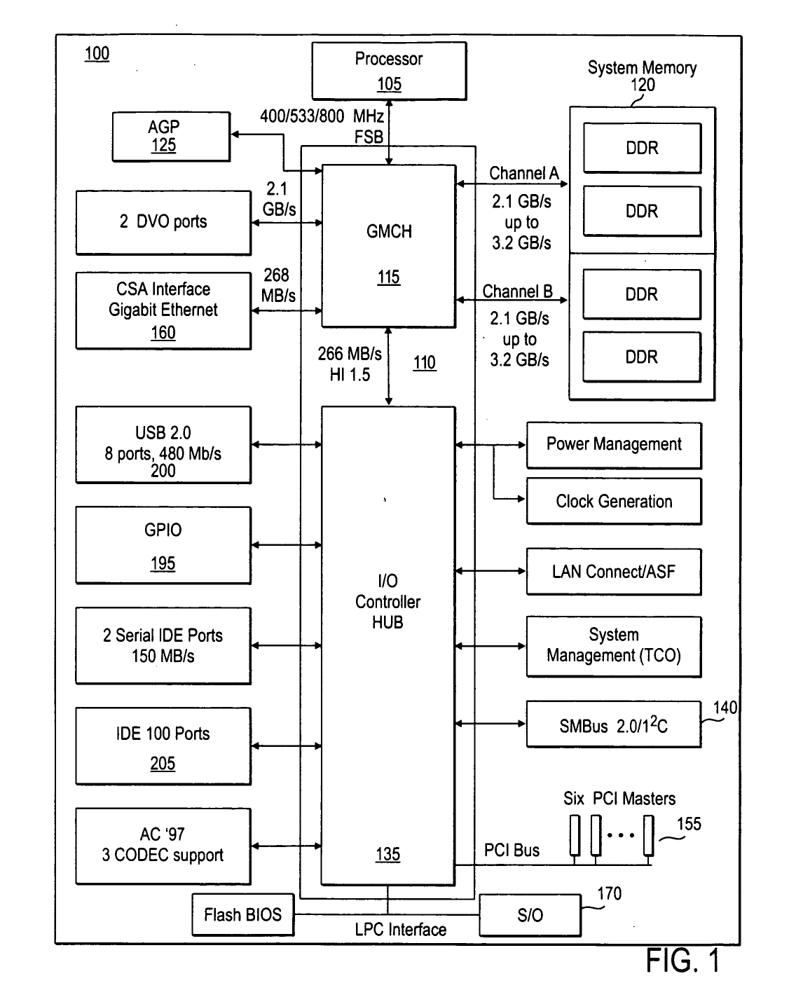

FIG. 1 illustrates a block diagram of an exemplary computer system 100 utilizing the present method and apparatus, according to one embodiment of the present invention. Computer system includes a processor 105. Chipset 110 provides system 100 with memory and I/O functions. More particularly, chipset 110 includes a Graphics and Memory Controller Hub (GMCH) 115. GMCH 115 acts as a host controller that communicates with processor 105 and further acts as a controller for main memory 120. GMCH 115 also provides an interface to Advanced Graphics Port (AGP) controller 125 which is coupled thereto. Chipset 110 further includes an I/O Controller Hub (ICH) 135 which performs numerous I/O functions. ICH 135 is coupled to a System Management Bus (SM Bus) 140.

ICH 135 is coupled to a Peripheral Component Interconnect (PCI) bus 155. A super I/O (“SID”) controller 170 is coupled to ICH 135 to provide connectivity to input devices such as a keyboard and mouse 175. A General-purpose I/O (GPIO) bus 195 is coupled to ICH 135. USB ports 200 are coupled to ICH 135 as shown. USB devices such as printers, scanners, joysticks, etc. can be added to the system configuration on this bus. An integrated drive electronics (IDE) bus 205 is coupled to ICH 135 to connect IDE drives 210 to the computer system. Logically, ICH 135 appears as multiple PCI devices within a single physical component.

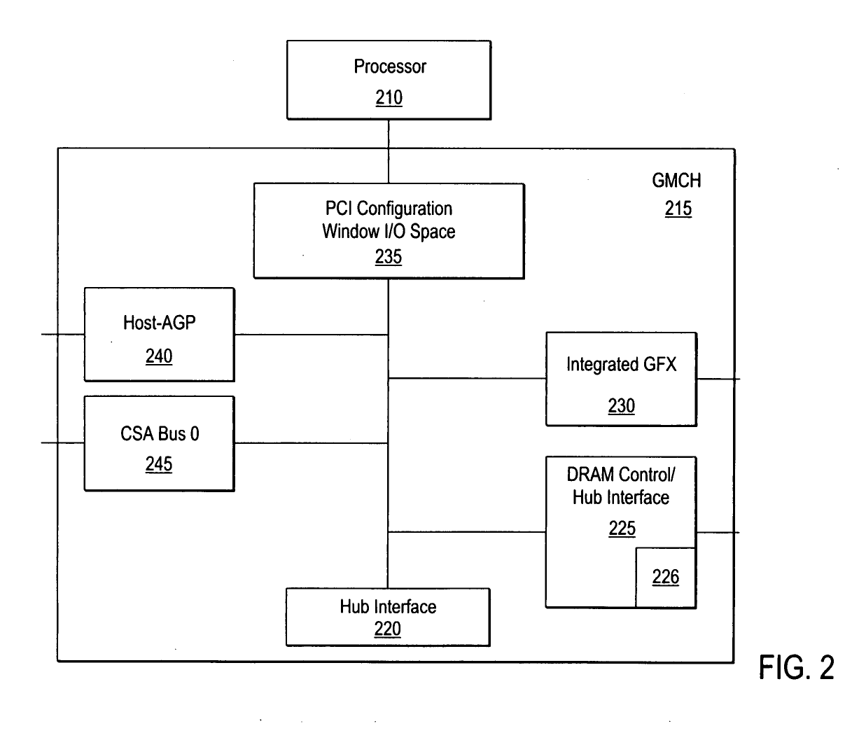

FIG. 2 illustrates a block diagram of an exemplary graphics memory controller hub with processor that utilizes the present method and apparatus, according to one embodiment of the present invention. GMCH 215 is a graphics memory controller hub, such as GMCH 115. GMCH 215 includes a hub interface 220 for interconnecting GMCH 215 with an I/O controller hub, such as ICH 135. Communication streaming architecture (CSA) bus 245 connects to an ethernet controller such as gigabit ethernet controller 160. Peripheral component interconnect (PCI) configuration window I/O space 235 is a combined interface and buffer for processor 210. A host-to-AGP bridge 240 provides access to an AGP controller, such as AGP controller 125. An integrated graphics controller 230 receives requests from processor 210 and an external graphics engine (not shown) to generate graphics. Also included in GMCH 215 is a DRAM Controller 225 that allows access to system memory such as system memory 120. Included in DRAM controller 225 is a cache 226. DRAM controller 225 dedicates cache entries to certain streams for performance optimization.

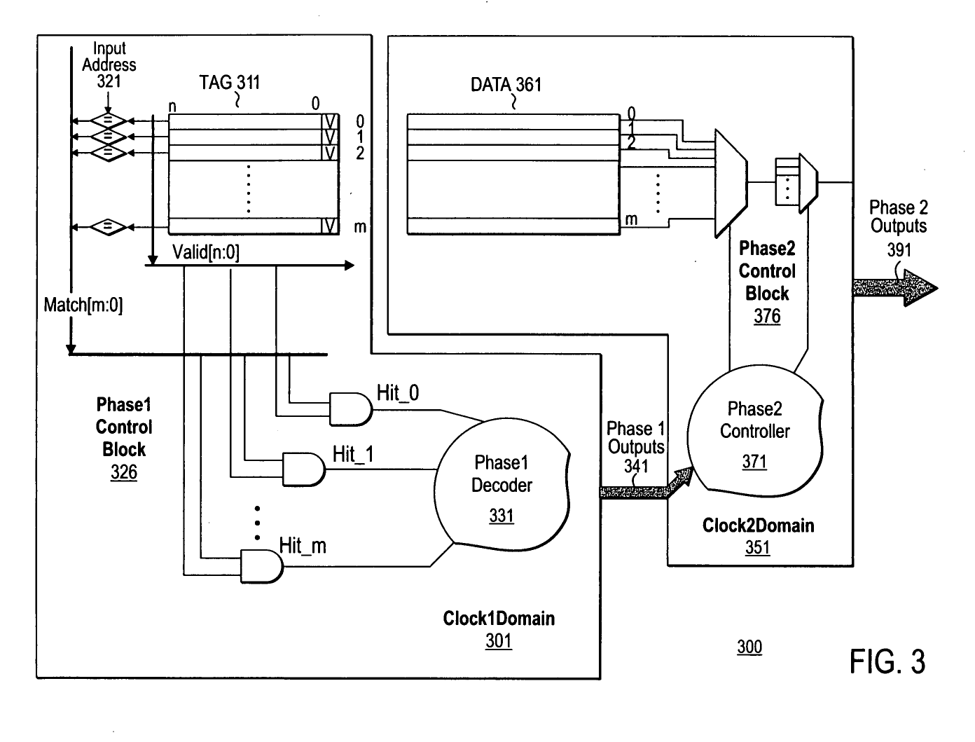

FIG. 3 illustrates a block diagram of an exemplary two-phase cache, according to one embodiment of the present invention. Two-phase cache 300 could be integrated within DRAM controller 225, as cache 226, as a cache within processor 210, or any similar data cache. As stated above, tag and data components of cache entries have traditionally been used in the same clock domain. The address and status of the tag field of a traditional cache entry represents the actual state of data associated with that entry at any time. In other words, the tag and data fields of a traditional cache entry are always in the same phase.

The present two-phase cache 300 includes two clock domains: clock 1 domain 301, and clock 2 domain 351. Clock 1 domain 301 includes tag field 311 and phase 1 control block 326. Phase 1 control block 326 includes a decoder 331 and accepts input addresses 321. Clock 2 domain 351 includes data field 351 and phase 2 control block 376. Phase 2 control block 376 includes a phase 2 controller 371 that receives phase 1 outputs 341.

The reader can see that cache 300 is used as two separate logical entities, since tag field 311 and data field 351 are updated and used in different phases and different clock domains. Instead of the tag representing the present status of the data field of an entry, a tag field 311 entry represents what may be the state of its corresponding data field 351 entry at some point in the future.

Clock 1 domain 301 performs tag lookup (i.e., determining if the input address 321 of a data request matches the addresses stored in tag field 311) (i.e., a cache “hit”). Clock 2 domain 351 is valid during phase 2 of the caching operation. More specifically, phase 1 decoder 331 passes pointers to phase 2 controller 371. The phase 1 outputs 341 include these pointers that indicate which data field 351 entries are to be checked during the second phase. According to one embodiment, phase 1 of domain 301 and phase 2 of domain 351 operate in different clock domains, as illustrated. However, in alternate embodiments, the two-phases may operate in the same clock domain. In other words, since tag field 311 and data field 351 have been separated over time, it is possible to maintain the two fields in different clock domains. There need not be any relationship between the clock domains that tag field 311 and data field 351 operate in.

The two-phase cache 300 described above enables a “cache miss” to be treated like a “cache hit,” and enable the “cache miss” cycle to be pipelined right after the cache fetch. For example, consider the scenario described above, where a first request for data in memory 120 results in a cache miss by cache 226. A second request for the same data is made before the fetch operation for the first request has executed. A traditional cache would generate a second cache miss, but cache 300 enables the second cache miss to be treated like a cache hit. In the traditional cache scenario, the second cache miss would have to be stalled until the cache “fetch” for the first “cache miss” is returned. That would add additional latency to the second request. The present method and cache 300, effectively hides the latency required for the second request behind the latency of the first request, more specifically, the cache-fetch operation triggered by the first cache miss.

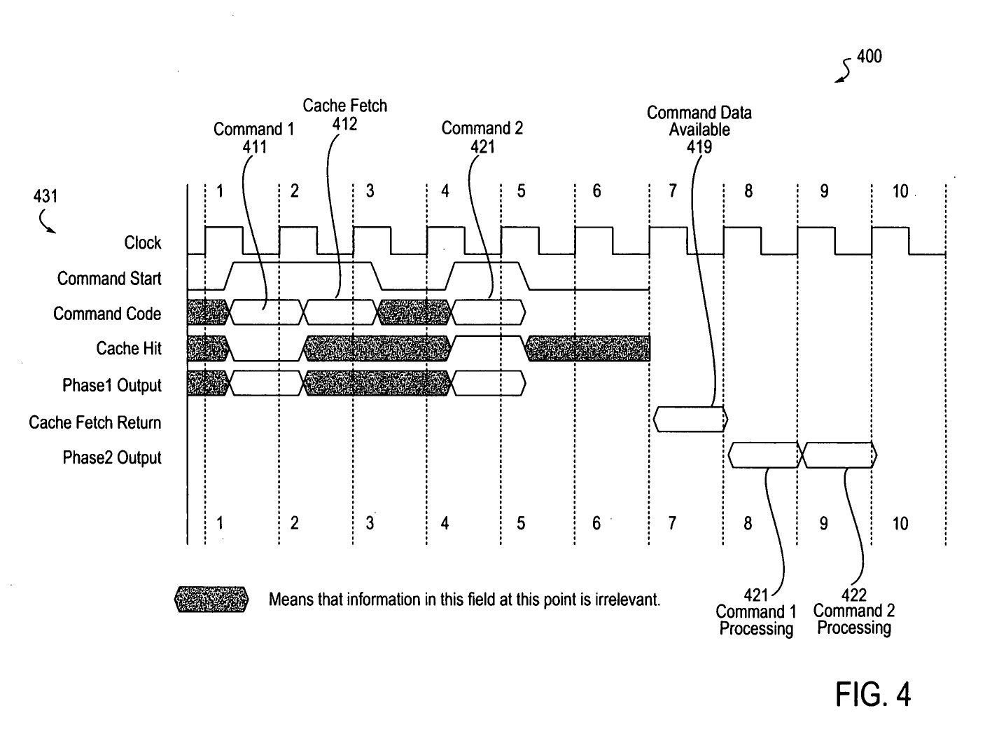

FIG. 4 illustrates an exemplary timing diagram of a two-phase cache operation, according to one embodiment of the present invention. Timing diagram 400 does not illustrate the actual clock signals where operations are performed. Instead, the clock signal 431 has been numbered to demonstrate the sequence of operations as time progresses conceptually.

Timing diagram 400 indicates two commands (i.e., command 1 411, and command 2 421) that require cache lookups. The first command, “command 1” 411, appears in clock 1, and the second command., “command 2” 421, appears in clock 5. Command 1 411 results in a “cache miss.” A corresponding cache “fetch” 412 is launched for command 1 411 in clock 3.

The second command, command 2 421 requests the same cache entry as command 1 411. Even though the “cache fetch” data 419 for the “cache miss” of command 1 411 is not available until clock 7, command 2 421 is marked as a “cache hit.” Command 2 421 is marked as a “cache-hit” even though cache 300 does not contain valid data yet since the cache 300 will have valid data by the time the second phase of the cache operation is ready to operate on the data.

As stated above, cache data 419 is available at clock 7, command 1 and command 2 processing 421, 422 are processed at clocks 8 and 9. The reader can understand from FIG. 4, that a traditional cache would result in a cache miss for command 2 421, and would not provide command 2 processing as quickly, such as an additional 2-3 clock cycle delay. The present cache 300 improves latency on memory accesses, thus, providing better performance on cache miss cycles.

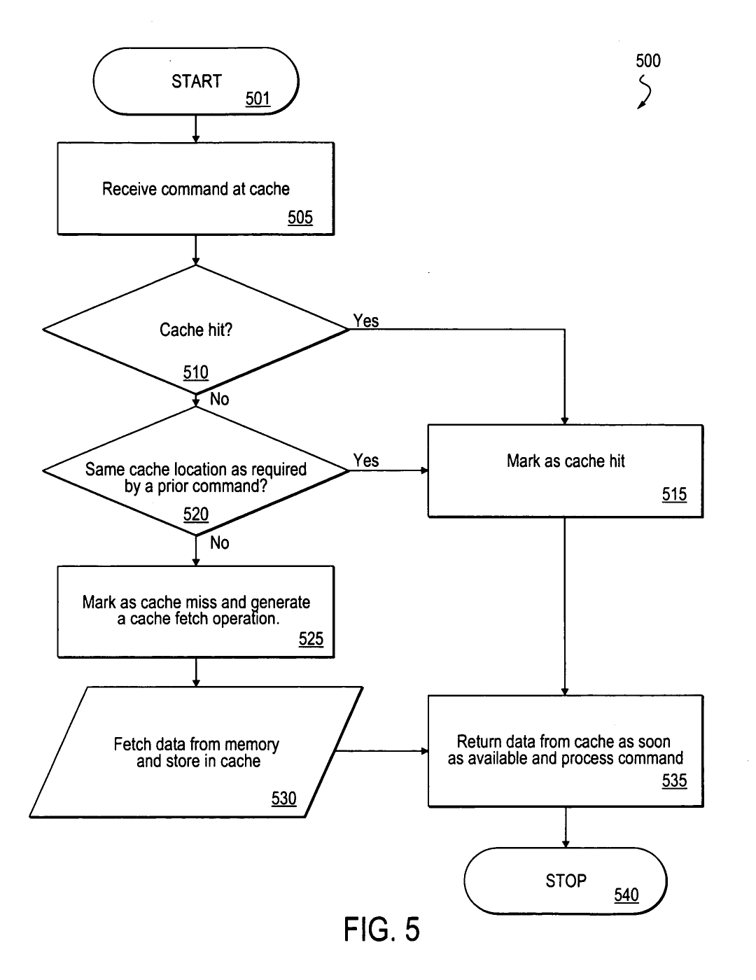

FIG. 5 illustrates a flow diagram of an exemplary process 500 for providing a two-phase cache, according to one embodiment of the present invention. A command (such as command 2 421) is received at cache 300. (processing block 505) Cache 300 determines if the command makes a request for data already stored in cache 300 (decision block 510). If the command requests data that is already stored in cache 300, then a cache hit is generated (processing block 515). If the data is not already stored in cache 300, cache 300 determines if the command makes a request for data from the same cache location that was required by a prior command (decision block 520). If a prior command generated a cache fetch for the same data, but the data is still not available, (i.e., a pending cache fetch for the data) cache 300 still marks the command as a “cache hit” (processing block 515). If there is no pending cache fetch in progress, then the command is marked as a “cache miss” and a cache fetch operation is generated.

(processing block 525) The requested data is fetched from memory and stored in cache 300. (data block 530) As soon as it is available, the data is returned to the requesting entity from cache 300, and command processing occurs (processing block 535). If a cache hit occurred at block 510, the requested data is available immediately, since it was already stored in cache 300. However, if a cache hit is generated because a pending cache fetch would return the requested data (decision block 520), then the data may not be immediately available. In that case, the requested data is returned and processed as soon as it is available. The process completes once all requested data is returned (termination block 540).

A method and apparatus for splitting a cache operation into multiple phases and multiple clock domains are disclosed. Although the present embodiments of the invention have been described with respect to specific examples and subsystems, it will be apparent to those of ordinary skill in the art that the present embodiments of the invention are not limited to these specific examples or subsystems but extends to other embodiments as well. The present embodiments of the invention include all of these other embodiments as specified in the claims that follow.

1. A method, comprising:
splitting a cache operation into two or more phases and two or more clock domains.

2. The method as claimed in claim 1, further comprising
receiving the cache operation at a cache, wherein the cache operation requests data; and
returning a cache hit in response to the cache operation, wherein the cache has a pending fetch for the data in response to a prior cache operation requesting the data.

3. The method as claimed in claim 2, where in response to the prior cache operation, the data has been requested from memory but has not yet been stored in the cache at a time when the cache receives the cache operation.

4. The method as claimed in claim 3, wherein the cache operation includes a tag field maintained in a first phase of the two or more phases and a data field in a second phase of the two or more phases.

5. The method as claimed in claim 3, wherein the cache operation includes a tag field maintained in a first clock domain of the two or more clock domains and a data field in a second clock domain of the two or more clock domains.

6. The method as claimed in claim 3, further comprising returning the data from the cache once the data is available.

7. A device comprising:
a cache memory array; and
control logic coupled to the cache memory array, wherein the control logic divides a cache operation into two or more phases and two or more clock domains.

8. The device as claimed in claim 7, wherein the cache memory array:
receives the cache operation that requests data; and
returns a cache hit in response to the cache operation, wherein the cache array has a pending fetch for the data in response to a prior cache operation requesting the data.

9. The device as claimed in claim 8, wherein the control logic further comprises:
a decoder connected to the cache memory array; and
a controller connected to the decoder.

10. The device as claimed in claim 9, where in response to the prior cache operation, the data has been requested from memory but has not yet been stored in the cache at a time when the cache array receives the cache operation.

11. The device of claim 10, further comprising a DRAM controller integrated with the cache memory array.

12. The device of claim 11, further comprising an integrated graphics controller, a host AGP controller, and an I/O hub interface.

13. A computer-readable medium having stored thereon a plurality of instructions, said plurality of instructions when executed by a computer, cause said computer to perform the method of:
splitting a cache operation into two or more phases and two or more clock domains.

14. The computer-readable medium of claim 13, having stored thereon additional instructions, said additional instructions when executed by a computer, cause said computer to further perform the method of:
receiving the cache operation at a cache, wherein the cache operation requests data; and
returning a cache hit in response to the cache operation, wherein the cache has a pending fetch for the data in response to a prior cache operation requesting the data.

15. The computer-readable medium of claim 14, where in response to the prior cache operation, the data has been requested from memory but has not yet been stored in the cache at a time when the cache receives the cache operation.

16. The computer-readable medium of claim 15, wherein the cache operation includes a tag field maintained in a first phase of the two or more phases and a data field in a second phase of the two or more phases.

17. The computer-readable medium of claim 15, wherein the cache operation includes a tag field maintained in a first clock domain of the two or more clock domains and a data field in a second clock domain of the two or more clock domains.

18. The computer-readable medium of claim 15, having stored thereon additional instructions, said additional instructions when executed by a computer, cause said computer to further perform the method of returning the data from the cache once the data is available.

19. A system, comprising:
a system memory controller, comprising
a cache memory array, and
control logic coupled to the cache memory array, wherein the control logic divides a cache operation into two or more phases and two or more clock domains; and
system memory connected to the system memory controller.

20. The system as claimed in claim 19, further comprising
one or more interfaces connected to the system memory controller, including
an I/O hub interface connected to a bus,
a processor interface; and
a host AGP controller connected to the system memory controller via the bus;
wherein the cache array receives the cache operation requesting data via the one or more interfaces, and returns a cache hit in response to the cache operation, wherein the cache has a pending fetch for the data in response to a prior cache operation requesting the data.

21. The system as claimed in claim 20, where in response to the prior cache operation, the data has been requested from the system memory but has not yet been stored in the cache at a time when the cache receives the cache operation.

22. The system as claimed in claim 21, wherein the cache operation includes a tag field maintained in a first phase of the two or more phases and a data field in a second phase of the two or more phases.

23. The system as claimed in claim 21, wherein the cache operation includes a tag field maintained in a first clock domain of the two or more clock domains and a data field in a second clock domain of the two or more clock domains.
